(19) United States
(12) Patent Application Publication
(10) Pub. No.: US 2014/0324692 A1
(43) Pub. Date: Oct. 30, 2014

(54) SYSTEMS AND METHODS FOR IMPLEMENTING INSTANT PAYMENTS ON MOBILE DEVICES

(71) Applicants: Joel Yarbrough, Oakland, CA (US); Hyunju Lee, Singapore (SG); Francisco C. Barretto, San Jose, CA (US)

(72) Inventors: Joel Yarbrough, Oakland, CA (US); Hyunju Lee, Singapore (SG); Francisco C. Barretto, San Jose, CA (US)

(21) Appl. No.: 14/260,046

(22) Filed: Apr. 23, 2014

Related U.S. Application Data
(60) Provisional application No. 61/829,096, filed on May 30, 2013.
(60) Provisional application No. 61/816,629, filed on Apr. 26, 2013.

(51) Int. Cl. G06Q 20/32

(52) U.S. Cl. CPC G06Q 20/32
USPC 705/42

(57) ABSTRACT

A system and/or method may be provided to implement instant payments on mobile devices. In particular, the system may allow a user to designate websites or mobile apps at which the user may make instant payments without user authentication. As such, when the user makes payments at the designated website or mobile app, the system may process payments without requesting the user's user ID and/or password. For example, instant payments may be made by two operations from the user, e.g., two clicks. In particular, the user may click a button to request payment and click another button to confirm payment. Thus, the user may make payments quickly without additional efforts.

### CROSS REFERENCE TO RELATED APPLICATION

Pursuant to 35 U.S.C. §119(e), this application claims priority to U.S. Provisional Patent Application No. 61/816,629, filed on Apr. 26, 2013 and U.S. Provisional Patent Application No. 61/829,096, filed on May 30, 2013, both of which are incorporated by reference in their entirety.

### BACKGROUND

1. Field of the Invention

The present invention generally relates to systems and methods for implementing instant payments on mobile devices.

2. Related Art

In today's commerce, many payment transactions, such as retail purchases, payment transactions, and the like, are made electronically using electronic devices, such as mobile phones or mobile computing devices. For example, a consumer may install a payment app on his or her mobile device to facilitate payments to various merchants or recipients. A payment process typically includes user authentication which requires a user to enter a login ID and/or a password to authenticate the user. Nevertheless, the authentication process may cause inconvenience to the user especially if the user is in a hurry or if a keyboard is not included with the mobile device for the user to type in the user ID or password. As such, the authentication process may delay the overall payment process and cause the payment process to take longer than making a payment with cash. Therefore, there is a need for a system or a method that implements instant payments on mobile devices.

### BRIEF DESCRIPTION OF THE FIGURES

FIG. 1 is block diagram of a networked system suitable for implementing instant payments on mobile devices according to an embodiment.

FIG. 2 is a flowchart showing a process for setting up instant payment functions according to one embodiment.

FIG. 3 is a flowchart showing a process for implementing instant payments according to one embodiment,

FIG. 4 is a block diagram of a computer system suitable for implementing one or more components in FIG. 1 according to one embodiment.

FIG. 5 is a diagram showing various user interfaces for setting up instant payment functions according to one embodiment.

FIG. 6 is a diagram showing various screens for making an instant payment at a merchant website according to one embodiment.

FIG. 7 is a diagram showing various screens for making an instant payment on a mobile app according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system and/or method may be provided to implement instant payments on mobile devices. In particular, the system may allow a user to designate websites or mobile apps at which the user may make instant payments without user authentication. As such, when the user makes payments at the designated website or mobile app, the system may process payments without requesting the user's user ID and/or password. For example, instant payments may be made by two operations from the user, e.g., two taps or clicks. In particular, the user may tap a button to request payment and tap another button to confirm payment. Thus, the user may make payments quickly without additional effort.

In an embodiment, an interface may be provided for the user to designate various instant payment settings for different websites and/or mobile apps. For example, the user may selectively toggle, e.g., turn on and off, the instant payment feature for each websites and mobile apps. In another embodiment, after an initial user authentication is done for making a payment at a particular mobile app or website, subsequent payments for the particular mobile app or website may be made instantly without authentication for a predetermined length of time, unless the user specifically logs out or the mobile device is unlocked without authentication. In some embodiments, the instant payment mode may time-out for a website or a mobile app after a period of inactivity. Different websites or mobile apps may have different lengths of time-out periods based on user setting, usage history, security requirements for a website or mobile app, and the like. Further, an indicator may be provided to show the user which app or website currently is in instant payment mode.

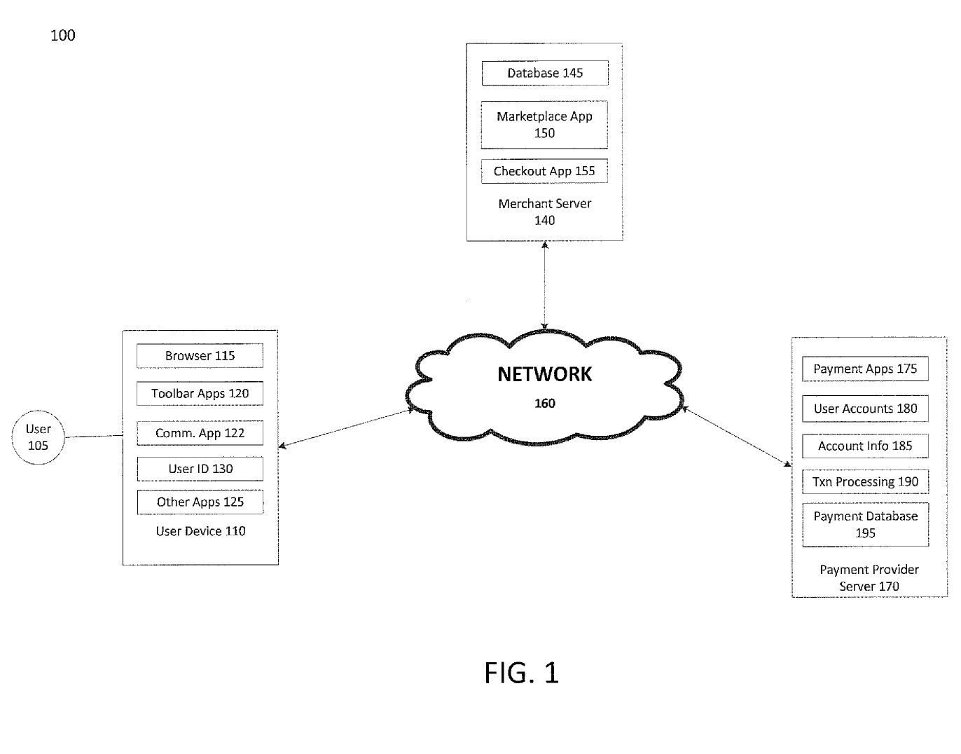

FIG. 1 is a block diagram of a networked system 100 configured to implement a process for implementing instant payments on mobile devices in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, wearable device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a smart wallet through the payment provider as discussed above.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may install and execute a payment application received from the payment service provider to facilitate payment processes. The payment application may allow user to send payment transaction requests to the payment service provider. In particular, the payment application may authenticate user 105 before making payments. In an embodiment, the payment application may allow certain pre-designated applications or websites executed on user device 110 to make instant payments without user authentication.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be a donation to charity. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 105. Account information may also include user purchase history and user ratings. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

In one embodiment, payment provider server 170 may receive information related to apps or websites designated by user 105 for instant payments at user device 110, e.g., without the user having to provide login or authentication information. For example, a group of apps or websites may be designated at which user authentication is omitted during a payment process. User 105 may select websites or apps that are in this instant payment mode. Further, a time-out period may be designated for the websites or apps that are in the instant payment mode. In particular, the instant payment mode may expire after the time-out period. The time-out period may be set based on various factors, such as type of app/website, usage history, user preferences, security requirement, amount of transaction, location of user, and the like. The time-out period may also be specified, in one embodiment, by the user and may depend on amount of transaction, e.g., the higher the transaction amount, the shorter the period required before authentication or login information is required.

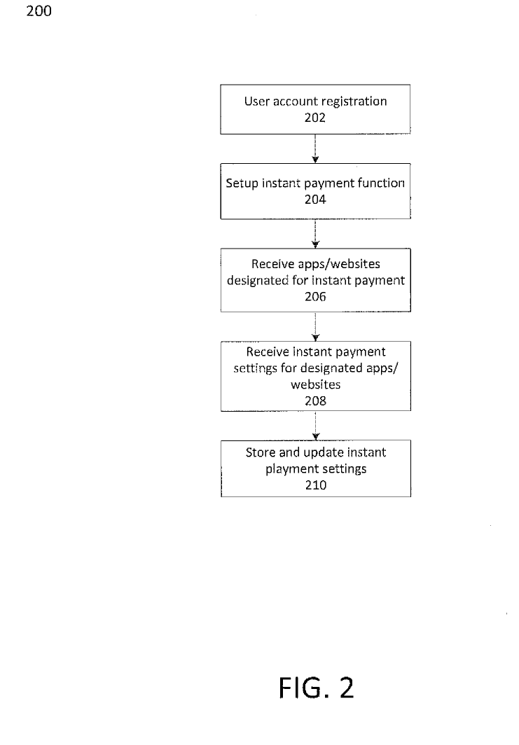

FIG. 2 is a flowchart showing a process 200 for setting up instant payment functions according to one embodiment. At step 202, payment provider server 170 may receive user 105's account registration. In particular, user 105 may set up a payment account at the payment service provider to make and receive payments. User 105 may set up funding sources, such as credit card accounts, bank accounts, and the like, to fund the payment account. User 105 also may provide various personal information for additional security checks. For example, user 105 may set up a login ID and a password for accessing the payment account. As such, user 105 may be authenticated when making a payment using the payment account by entering user 105's ID and password. Other authentication methods, such as finger print scanning, voice recognition techniques, or facial recognition techniques, also may be utilized for authentication.

At step 204, an instant payment function may be set up for user 105's payment account. For example, payment provider server 170 may inquire user 105 whether user 105 wants to utilize the instant payment function to make payments without the authentication process, e.g., without entering user ID and password. User 105 may agree to or deny the instant payment function in the payment application. At step 206, if user 105 agrees to use the instant payment function, payment provider server 170 may ask user 105 to designate websites or mobile apps installed on user device 110 that may use the instant payment function. For example, user 105 may designate a shopping app that may use the instant payment function, such that user 105 may have the option of making payments without user authentication when using the shopping app.

In some embodiments, payment service provider may pre-screen websites or mobile apps and pre-qualify certain websites or mobile apps for the instant payment function. For example, payment service provider may screen websites or mobile apps to make sure that are from legitimate business with good credit ratings or good ratings, such as from Better Business Bureau (BBB). Websites or mobile apps operated by merchants that meet certain standards may be qualified by the payment service provider to use the instant payment function. When user designate mobile apps or websites, payment provider server 170 may check the user designated mobile apps or websites with a list of qualified mobile apps or websites. If the designated mobile app or website is not qualified by the payment service provider, payment provider server 170 may inform user 105 that the designated mobile app or website is not qualified for the instant payment function.

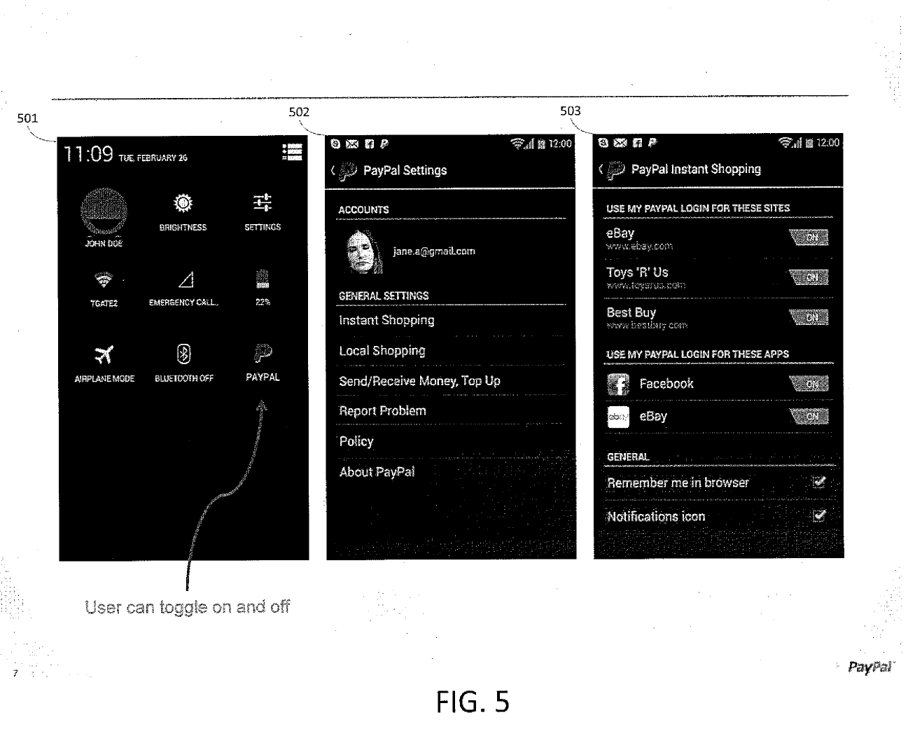

At step 208, payment provider server 170 may receive instant payment settings for the designated apps/websites. For example, as shown in FIG. 5, screen 501 depicts a settings menu of a mobile device including icons of a plurality of apps. A PayPal icon may be activated to access the various settings of a PayPal app, which is a payment application from a payment service provider, PayPal Inc. If user 105 activates the PayPal icon in screen 501, screen 502 may be displayed. Screen 502 may include a menu for a plurality of general settings including settings for instant shopping. Settings for instant shopping may include settings for instant payment.

If user 105 activates settings for instant shopping in screen 502, screen 503 may be displayed. Screen 503 may display a list of mobile apps and/or websites that may implement instant payment. For example, as shown in screen 503, websites that may implement the instant payment feature may include eBay, Toys “R” Us, and Best Buy. Each of these websites is listed along with a toggle switch to its right side. User 105 may operate the toggle switch to turn on or turn off the instant payment mode, e.g., using login credentials for the user's payment provider account for one or more of the different merchant sites. Similarly, a list of mobile apps, such as Facebook or eBay, is presented with toggle switches for user 105 to selective toggle on or off the instant payment mode for the mobile apps.

An option for “Remember me in browser” is presented to allow user 105 to select whether a user's login should be remembered for instant payment. For example, after user 105 initially logs in and is authenticated for instant payment for a particular website, the instant payment login may be remembered for a predetermined amount of time during which the instant payment feature may remain active to allow user to make payments in the particular website without authentication. After the predetermined amount of time is timed out, user 105 may then be required to log in and be authenticated again before using the instant payment feature for the particular website. The length of time which the user is remembered for a particular website or mobile app may be adjusted by user 105.

In an embodiment, the length of time, during which user 105's login is remembered for instant payments, may depend on the type of websites or mobile apps and the security requirement of the respective websites or mobile apps. In some embodiments, user 105 may be allowed to make instant payments up to a certain amount during the period in which user 105's login for instant payments is remembered. If user 105 wishes to make a payment above the certain amount, user 105 may be required to log in and be authenticated again even during the period in which user 105's login for instant payment is remembered.

In an embodiment, user 105 may automatically be logged out of the instant payment feature after a certain period of inactivity in the website or the mobile app. The certain period may be set based on how often the website or the mobile app is visited or used by user 105. For example, if the website or the mobile app is used often by user 105, the instant payment feature may be timed out slower. In an embodiment, the certain period may be set based on how much secured content is used in the website or the mobile app. For example, if a large amount of secured or confidential information of user 105 is used in the website or the mobile app, the instant payment period may be timed out faster.

In an embodiment, a notification may be generated to notify user 105 that the instant payment mode for a certain mobile app or website is about to time out. The notification may include an option for user 105 to delay the time out. For example, a notification “Instant Payment mode for shopping app will time out in 30 seconds. Press the “delay timeout” button to keep the shopping app in instant payment mode” may be generated and present to user 105. User 105 may choose to delay this timeout by pressing the delay timeout button.

Screen 503 may include an option for setting notification icon. The notification icon may be displayed to user 105 to indicate that the instant payment feature is turned on or effective for a certain mobile app or website. For example, a notification icon for PayPal with an image of “P” may be displayed on a top left corner of the screen of user device 110 when user 105 is viewing a mobile app or a website that is currently in the instant payment mode. The notification may not be displayed when user 105 is viewing a mobile app or a website that is not currently in the instant payment mode. User 105 may selective turn on or off this display feature based on user 105's preference.

At step 210, payment provider server 170 may store and update various settings related to the instant payment feature. For example, each app or website may have its own user preferences for instant payment, such as timeout period, icon display settings, maximum payment allowed, and the like. Payment provider server 170 may store these settings in an instant payment setting database and may implement these settings accordingly. Any changes to the settings may be updated to the database.

By using the above process 200, user 105 may designate various mobile apps or websites to use the instant payment feature. Thus, user 105 may make instant payments without user authentication when using the designated mobile apps or websites. Further, various settings for the instant payment feature may be set up for each designated mobiles apps or websites based on user 105's preferences. As such, the status of instant payment may continuously be updated based on current conditions and/or user settings.

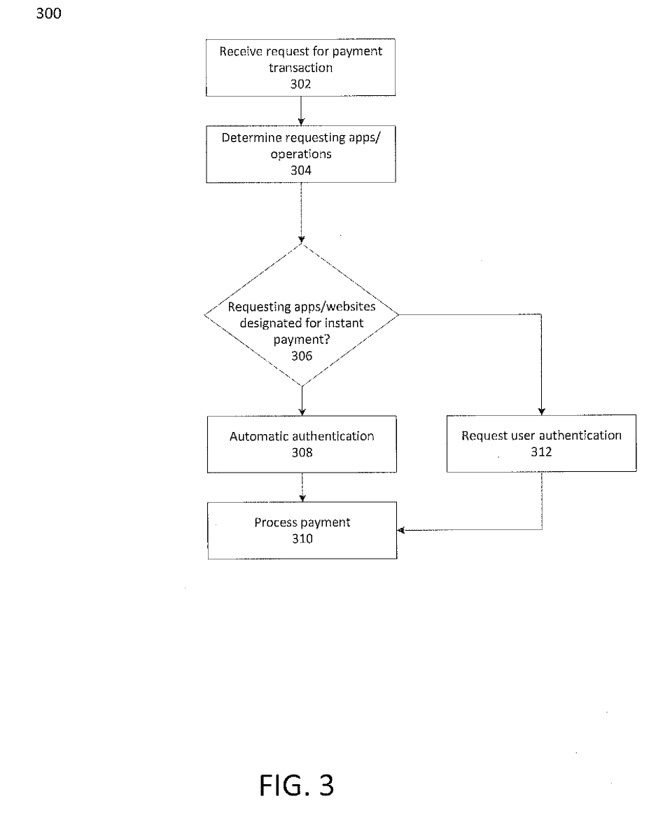

FIG. 3 is a flowchart showing a process for implementing instant payments according to one embodiment. At step 302, payment provider server 170 may receive a request for payment transaction from user 105. For example, user 105 may wish to make a payment using user device 110 and may send a payment request to payment provider server 170. At step 304, payment provider server 170 may determine the mobile app or the website from which the payment request is initiated or sent. For example, the payment request may be generated from a shopping app installed on user device 110 when user 105 is using the shopping app to make a purchase.

At step 306, payment provider server 170 may determine whether the mobile app or the website, from which the payment request is initiated, is designated for the instant payment feature. As noted above, different mobile apps or websites may be designated by user 105 or by default to implement instant payment. Under various conditions or settings, certain mobile apps or websites may implement the instant payment mode to allow payment without authentication. Payment provider server 170 may look up a list of designated mobile apps or websites to determine whether the mobile app or website that is requesting payment is in the list of designated mobile apps or websites for instant payment.

If the requesting mobile app or website is not designated for instant payment, payment provider server 170 may request user authentication at step 312. For example, payment provider server 170 may request user 105 to enter a user ID and password associated with user 105's payment account at the payment service provider. User 105 may be authenticated if user 105 enters the correct user ID and password. Other authentication techniques, such as voice recognition, facial recognition, finger print scanning or the like also may be implemented to authenticate user 105. If user 105 is authenticated, payment provider server 170 may process the requested payment at step 310. For example, payment provider server 170 may debit a payment amount from user 105's payment account and credit the payment amount to a payee's account.

If the requesting mobile app or website is designated for instant payment, payment provider server 170 may determine whether instant payment may be implemented based on other conditions and instant payment settings associated with the requesting mobile app or website. For example, payment provider server 170 may determine whether the payment amount is below the maximum instant payment limit or whether the instant payment mode is still in effect, e.g., has not expired. If the other conditions are satisfied based on instant payment settings, payment provider server 170 may automatically authenticate user 105 without user 105's input at step 308. Other conditions may include, individually or in combination, whether a maximum number of instant payment transactions during a certain period, whether the location of the user allows instant payment, whether the payment request is within a certain allowed period of the day, week, or month, etc. For example, user 105 may not need to provide ID or password. As such, payment provider server 170 may process payment at step 310 without user authentication. For example, payment provider server 170 may debit a payment amount from user 105's payment account and credit the payment amount to a payee's account. In one embodiment, after a successful payment, the timer for the instant payment feature is reset for that particular app or website. In another embodiment, if the instant payment feature is enabled only for a certain number of transactions, an instant payment counter is incremented.

In the above processes, the steps are executed at payment provider server 170. In one embodiment, the steps may be executed at user device 110 or merchant server 140. In still another embodiment, the steps may be executed among payment provider server 170, user device 110, and merchant server 140 in coordination with each other.

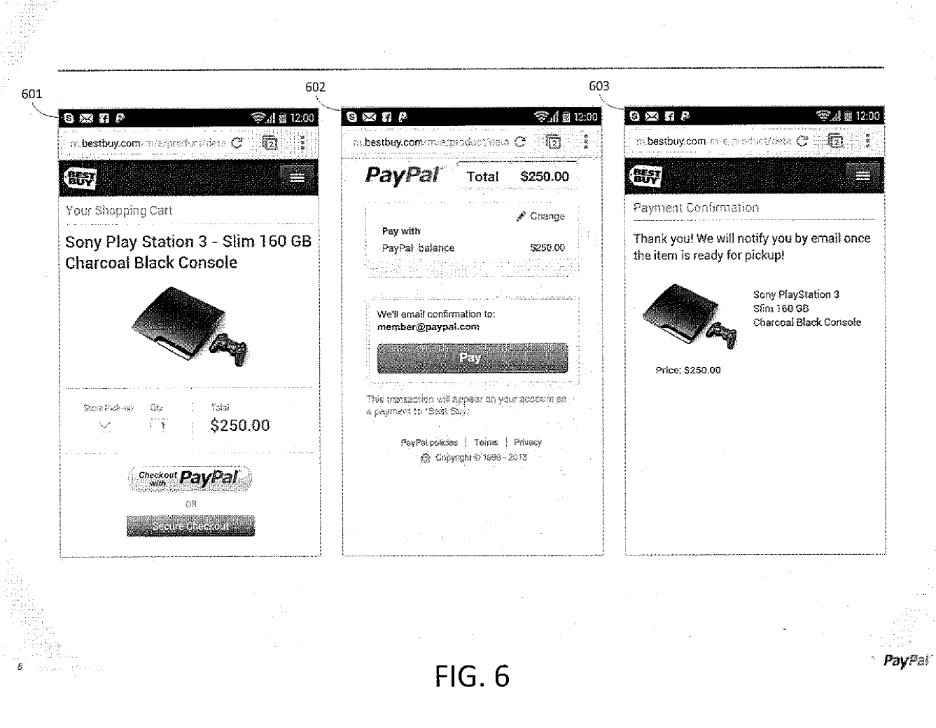

Referring to FIG. 6, exemplary screens 601-603 for making an instant payment at a website are illustrated. Screen 601 shows a checkout screen at which a user is ready to pay for a purchase at an online BestBuy store. Buttons are provided to allow user to pay with PayPal, an online payment service provider. As shown on screen 601, a PayPal icon “P” is displayed at a upper left corner of the screen to indicate that the online BestBuy website is designated to be used with PayPal's instant payment function.

If the user selects the button to pay with PayPal, a payment request may be sent to PayPal's server from the user's mobile device. The payment request may include the identity of the payee, the identity of the user or the mobile device of the user, the product to be purchased, the amount of payment, and the status of instant payment for the BestBuy website. PayPal's server may determine that the user is using his/her mobile device to make a payment and that the BestBuy website is eligible for the instant payment function. PayPal's server also may confirm that the purchase amount is under the maximum allowed amount for instant payment, that the instant payment function for the website has not timed out, and that any other security conditions, as required by the instant payment settings for the BestBuy website, are satisfied. If all conditions are satisfied, the PayPal server may skip the user authentication process and allow the user to confirm the purchase, as shown in screen 602. The payment confirmation displayed in screen 602 may include a price of purchase, product purchased, and the like. Thus, a user may review and confirm the purchase.

After the user selects the pay button in screen 602, the purchase transaction is processed. In particular, the BestBuy account is credited with the payment amount and the same amount is deducted from the user's payment account. Screen 603 is displayed to confirm that the purchase and payment process has been completed successfully. Accordingly, the user may purchase a product, e.g., a Sony Play Station, from the online BestBuy store with two clicks without user authentication.

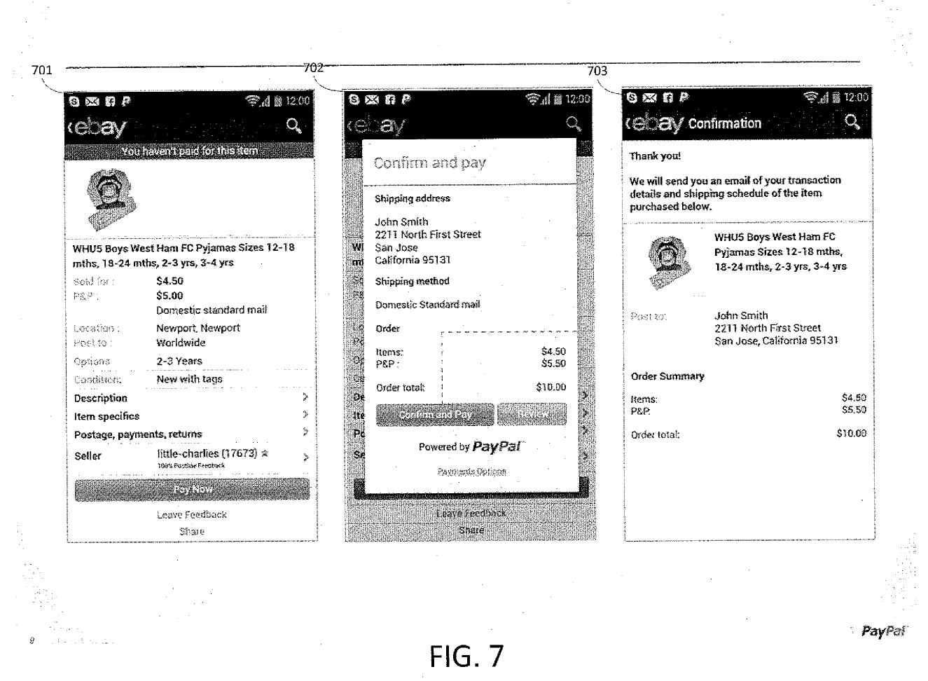

Referring to FIG. 7, exemplary screens 701-703 for making an instant payment at a website are illustrated. Screen 701 shows a checkout screen at which a user is ready to pay for a purchase using an eBay mobile app. A “Pay Now” button is provided to begin the payment process. As shown on screen 701, a PayPal icon “P” is displayed at an upper left corner of the screen to indicate that the eBay mobile app is designated to be used with PayPal's instant payment function.

If the user selects the “Pay Now” button to begin the payment process, a pop-up screen is displayed, as shown in Screen 702. The pop-up screen allows the user to confirm and pay for the purchase. In particular, a shipping address, a shipping method, a purchase amount including shipping fee is presented to the user for confirmation. If the user agrees to the purchase details, the user may press the “Confirm and Pay” button to proceed with the checkout and payment process. A payment request may be sent to PayPal's server from the user's mobile device. The payment request may include the identity of the payee, the identity of user, the product to be purchased, the amount of payment, and the status of instant payment for the BestBuy website. PayPal's server may determine that the user is using his/her mobile device to make a payment and that the eBay mobile app is eligible for the instant payment function. PayPal's server also may confirm that the purchase amount is under the maximum allowed amount for instant payment, that the instant payment function for the mobile app has not timed out, or that any other security conditions, as required by the instant payment settings for the eBay mobile app, are satisfied. If all conditions are satisfied, the PayPal server may skip the user authentication process and allow the user to complete the purchase, as shown in screen 703.

After the user selects the “Confirm and Pay” button in screen 702, the purchase transaction is processed. In particular, the merchant's account at eBay is credited with the payment amount and the same amount is deducted from the user's payment account. Screen 703 is displayed to confirm that the purchase and payment process has been completed successfully. Accordingly, the user may purchase a product, e.g., pajamas, from the eBay mobile app with two clicks and without user authentication.

In one embodiment, a screen or display on the user device shows all apps and/or sites where instant payment is enabled or active, such that the user can easily select, such as by tapping, a desired app or site to be directed to that app or site for shopping and/or payment. The display may also show how much longer a site is enabled for instant payment, such as with a timer or clock. Sites/apps that will be enabled longer may be visually indicated with a green image, ones that will be ending soon (e.g., less than an hour) may be shown with a red image, and ones that have a bit more time (e.g., more than an hour, but less than three hours) may be shown with a yellow colored image. Such visual indicators and/or audio indicators help users stay informed of status.

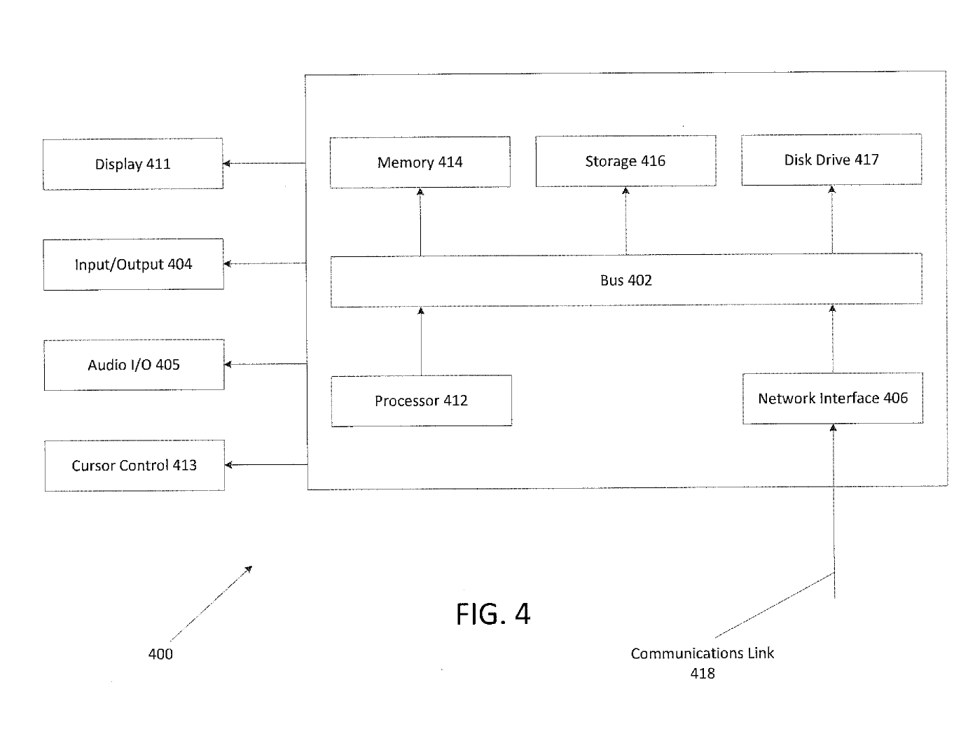

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing a payment account of a user; and
one or more processors in communication with the memory and adapted to:
receive a payment request from the user for making a payment at a website;
determine whether the website is designated for instant payments; and
process the payment request without authenticating the user when the website is designated for instant payment.

2. The system of claim 1, wherein the website is pre-designated by the user for instant payment.

3. The system of claim 1, wherein the website is designated for instant payment after security pre-screening.

4. The system of claim 1, wherein the payment request is processed without authenticating the user when the website is in an instant payment mode.

5. The system of claim 1, wherein the payment request is processed without authenticating the user when an amount of the payment is below a predetermined maximum amount.

6. The system of claim 4, wherein the website remains in the instant payment mode for a predetermined time period after an initial user authentication.

7. The system of claim 6, wherein the instant payment mode is timed out for the website after the user's inactivity at the website for the predetermined time period.

8. The system of claim 6, wherein the predetermined time period is determined based on a number of instant payment transactions processed through the website.

9. The system of claim 6, wherein the predetermined time period is determined based on a security content of the website.

10. The system of claim 6, wherein the predetermined time period is reset after an instant payment transaction is completed.

11. A method comprising:
receiving, by a hardware processor of a payment service provider, a payment request from a user of a payment account, wherein the payment request is for a payment made from an application installed at a device of the user;
determining whether the application is designated for instant payment; and
processing the payment request without authenticating the user when the application is designated for instant payment.

12. The method of claim 11, wherein the payment request is processed without authenticating the user when the application is in an instant payment mode.

13. The method of claim 12 further comprising:
generating an indicator indicating that the application is in the instant payment mode; and
display the indicator along with the application when the application is in the instant payment mode.

14. The method of claim 13, wherein the indicator is displayed at a peripheral portion of a screen of the device of the user.

15. The method of claim 12 further comprising:
generating a notification indicating that the application is about to be timed out of the instant payment mode; and
presenting the notification to the user at a predetermined moment before the application is to be timed out of the instant payment mode.

16. The method of claim 15, wherein the notification comprises an option selectable by the user to extend a time for the application to remain in the instant payment mode.

17. A non-transitory computer-readable medium comprising instructions which, in response to execution by a computer system, cause the computer system to perform a method comprising:
receiving a payment request from a user of a payment account, wherein the payment request is for a payment made from an application installed at a device of the user;
determining whether the application is designated for instant payment; and
processing the payment request without authenticating the user when the application is designated for instant payment.

18. The non-transitory computer-readable medium of claim 17,
wherein the application comprises an internet browser, and
wherein the method further comprises:
determining whether a website visited by the internet browser is designated for instant payment; and
processing the payment request without authenticating the user when the website is designated for instant payment.

19. The non-transitory computer-readable medium of claim 17, wherein the application switches between an instant payment mode in which payments are processed without authenticating the user and a non-instant payment mode in which payments processed with authenticating the user.

20. The non-transitory computer-readable medium of claim 19, wherein the application remains in the instant payment mode for a predetermined period of time after an initial user authentication.
